(19) United States
(12) Patent Application Publication
(10) Pub. No.: US 2003/0110919 A1
(43) Pub. Date: Jun. 19, 2003

(54) Tension-releasing bridge for use with stringed musical instruments

(76) Inventors: Charles A. Rattner, Stamford, CT (US); Michael J. Rattner, Stamford, CT (US)

Correspondence Address: Charles A. Rattner, Esq., 240 Wardwell Street #7, Stamford, CT, 06902, US

(21) Appl. No.: 10/189,150

(22) Filed: Jul. 3, 2002

Related U.S. Application Data
(63) Continuation-in-part of application No. 09/495,047, filed on Jan. 31, 2000, now Pat. No. 6,441,281.

(51) Int. Cl. G10D 3/04

(52) U.S. Cl. 84/298

(57) ABSTRACT

A bridge is mountable in a first secured position on a stringed musical instrument The bridge may be secured by a release mechanism such that when the release mechanism is activated, the distance between one end of a string being held by the bridge and a second end of the string secured elsewhere on the musical instrument is decreased, thereby decreasing the tension on the instrument caused by the tuning of the string. The bridge may be secured in a second released position from the body by a catch. The catch may include an adjustable arm for varying the distance at which the bridge is held in the second released position.

### CROSS-REFERENCE TO RELATED APPLICATIONS

This application is a continuation-in-part of pending U.S. patent application Ser. No. 09/495,047 entitled “TENSION-RELEASING BRIDGE FOR USE WITH STRINGED MUSICAL INSTRUMENTS” filed in the name of Charles A. Rattner and Michael J. Rattner on Jan. 31, 2000, the entirety of which is hereby incorporated by reference.

### FIELD OF THE INVENTION

This invention relates generally to music equipment and musical instruments and relates more particularly to bridges cooperating with a string tension releasing mechanism, including bridges on sounding boards, inverted bridges, bridges with string clamps or string holders, guitar bridges, and guitar bridges with tailpieces.

### BACKGROUND OF THE INVENTION

In a typical useful configuration, stringed musical instruments comprise a body, a neck, a head and a plurality of tuned strings. A standard neck is flat and is comprised of one or more types of wood, such as maple or rosewood. The head is attached to a first end of the neck and comprises one or more tuning pegs that hold the ends of the strings and accommodate the tuning thereof. The body is attached to an opposite end of the neck and comprises a bridge that is securely fastened to its upper face. The bridge secures the opposite ends of the strings to the body of the instrument. The strings are then tuned with the tuning pegs to resonate particular acoustic frequencies upon being plucked, strummed or otherwise disturbed.

Tuned strings create a tensile force across the neck. e.g. between the head and the body. Over time, this constant force may cause the neck of the instrument to bow or warp. When this happens the neck of the instrument is no longer flat. This condition adversely affects the tuning and intonation of the instrument over time. Additionally, the instrument becomes more difficult to play because the distance between the strings and the outer face of the neck typically becomes non-uniform with respect to the instrument's original structural and ornamental design. To correct this problem, the neck of the instrument must either be straightened or replaced. Either of these repairs are costly and must be performed as often as once a year.

It is possible to avoid damage to the neck by de-tuning the strings after each use of the instrument. However, stringed musical instruments may comprise or cooperate with as many as twelve strings. Hence, re-tuning each string before each use of an instrument can be very tedious. Because of this, many musicians choose not to de-tune the strings on their instruments after each use, thus allowing the progression of neck warping.

In order to avoid costly repairs and maintenance, it is desirable to introduce a device for a stringed musical instrument which prevents warping of the neck while allowing the strings to stay substantially tuned. It is further desirable that such device does not affect the quality of sound produced by the instrument due to its use. It is further desirable to make such a device mountable on pre-existing models of stringed instruments as well as on future models which may or may not contemplate the use of the device, so that all stringed instruments may be so equipped.

### BRIEF SUMMARY OF THE INVENTION

In order to address the problems of the prior art, a bridge system of the present invention is introduced which may be mountable on a stringed musical instrument having a body and a neck. The bridge system includes a bridge having a first end and a second end and a hinge operatively connected to the first end.

According to a further embodiment, a bridge system of the present invention may be mountable on a stringed musical instrument having a neck and a body. The bridge system includes a bridge having a first end and a second, wherein the first end is disposed closer to a neck than the second end. The bridge system further includes a holder for securing a plurality of strings and a guide for attaching the bridge to at least one rail.

According to a still further embodiment of the present invention a bridge system which may be mounted on a musical instrument having a body and a neck includes an end operatively connected to at least one spring mountable on the body. The at least one spring is positioned between the bridge and the body.

In certain embodiments it is contemplated that, in accordance with the instant invention a bridge of, for example, a stringed musical instrument may preferably be equipped to hold the ends of one or more strings of said instrument. The bridge may be releasably mounted to the body of the musical instrument such that when a release mechanism is activated, the tension of the strings may be reduced or eliminated. The bridge may not completely detach from the body of the instrument, but rather, may be repositioned so that the distance between the top and bottom of the one or more strings as measured along the body of the instrument may be decreased. The bridge may be returned to its original position by manual or mechanical depression when desired such that the one or more strings may be substantially returned to their original tuning. In certain embodiments it is contemplated that, in accordance with the instant invention, while a bridge is in its released position, there may be little or no tensile force between the top of the neck and the body. In this manner, the progression of neck warping due to the tensile force is greatly reduced.

It is, therefore, an advantage of certain embodiments of the instant invention that a bridge for a musical instrument is provided which allows for the release at least one string's tension between the neck and the body of a stringed musical instrument so as to reduce damage to the neck of the instrument over time.

It is a further advantage of certain embodiments of the instant invention that a bridge can manually be returned to its original position after release so that the at least one string's tension between the neck and body is substantially restored.

It is a still further advantage a bridge of the present invention may be incorporated into any model of previously existing stringed musical instruments.

A catch may further be provided with an arm for securing the bridge in a released position. The arm may be an adjustable securing arm that may be adjusted, thereby allowing a musician to select a position to which the bridge released upon actuation of the securing member.

### BRIEF DESCRIPTION OF THE DRAWINGS

Additional objects and advantages of the invention will become apparent to those of ordinary skill in the art from the detailed description of the invention provided below, in conjunction with the figures provided therewith, of which:

FIG. 1 is a front view of a stringed musical instrument illustrating a secured position of a bridge on a stringed musical instrument;

FIG. 2 is a side view of a bridge in a secured position on a prior art musical instrument;

FIG. 3 is a side view of the prior art musical instrument of FIG. 2 illustrating a position of a bridge attached to said instrument and the neck warping which may result therefrom;

FIG. 4 is a side view of a musical instrument illustrating the position of a released bridge in accordance with one embodiment of the instant invention;

FIG. 5A is a side view of a bridge in cooperation with a catch in accordance with one embodiment of the instant invention;

FIG. 5B is a side view of a bridge in cooperation with a release-and-hold device in accordance with one embodiment of the instant invention;

FIG. 6 is a side view of a bridge in cooperation with a spring mechanism in accordance with one embodiment of the instant invention;

FIG. 7A is a perspective view of a bridge of FIG. 5A;

FIG. 7B is a perspective view of a bridge of FIG. 5B; and

FIG. 8 is a perspective view of a bridge in cooperation with rails in accordance with one embodiment of the instant invention.

### DETAILED DESCRIPTION OF THE EMBODIMENT

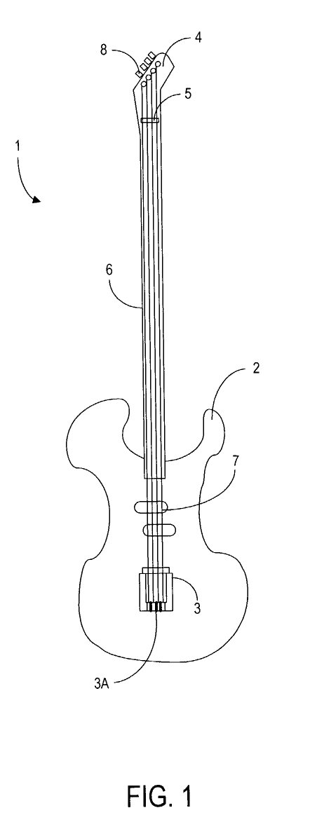

Referring now to FIGS. 1-8 wherein similar elements are numbered in like manner, FIG. 1 depicts a stringed musical instrument 1 having a body 2 for supporting a bridge 3. The bridge 3 may optionally include a string holder 3A. A head 4 includes a nut 5 for guiding a plurality of strings 7 which have first ends secured to a plurality of tuning pegs and knobs 8. A neck 6 is disposed between the head 4 and the body 2. When certain positions, such as frets (not shown) on the neck 6 are selected by a player of the instrument, the plurality of strings 7 may resonate at desired frequencies. Although musical instrument 1 is depicted as a guitar, it should be appreciated that the instrument 1 may be any stringed musical instrument having similar components, such as a cello, a violin, a bass guitar, a banjo and the like, wherein the strings of the instrument produce a tensile force between the head 4 and body 2 of the instrument when the plurality of strings 7 are tightened or tuned.

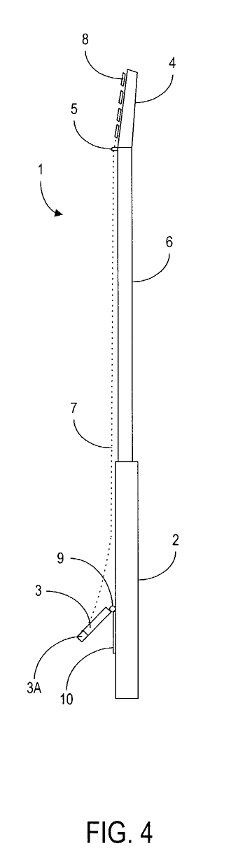

The appearance of the bridge 3 in FIG. 1 corresponds to that of bridges well known in the prior art or to a bridge of the instant invention wherein the bridge 3 is in a secured position on the body 2, as described further below with respect to FIGS. 4-8.

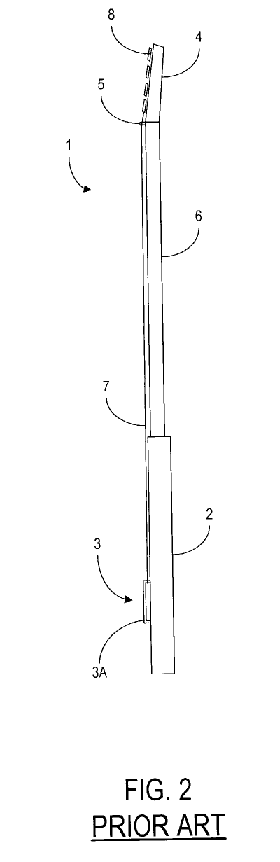

Turning now to FIG. 2, therein is depicted a side view of a prior art musical instrument 1 having the components described immediately above with respect to FIG. 1. In a new condition, the neck 6 of the instrument 1 is substantially flat.

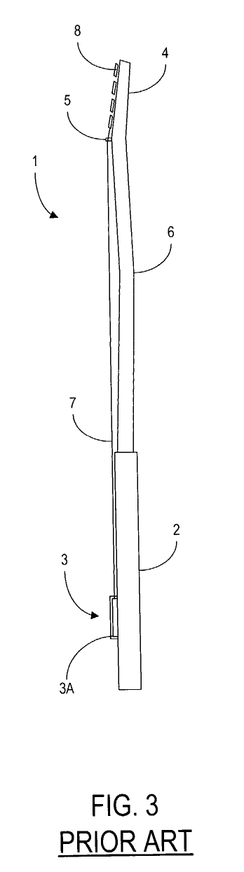

FIG. 3 depicts the musical instrument 1 of FIG. 2 wherein the tensile force created by the tuned strings 7 disposed between the head 4 and the body 2 causes the neck 6 to bend or warp. As depicted in FIG. 3, the distance between the plurality of strings 7 and the neck 6 is no longer uniform, making the instrument more difficult to play and affecting the intonation of the instrument 1.

Referring now to FIG. 4, therein is depicted a bridge system 11 according to one embodiment of the instant invention. The bridge system 11 includes a bridge 3, a holder 3A for a plurality of strings 7, a hinge 9 and a plate 10. The bridge 3 may be any bridge which is operatively connectable to a hinge 9 or any portion thereof. The hinge 9 may be any known hinge, a portion of a hinge or similar device which allows the bridge 3 to move between a first position (wherein the bridge is secured to the body 2) and second position (wherein an end of the bridge 3 is released from the body 2 as shown). The plate 10 may be any durable material, such as a metal, which may be operatively connected to the hinge 9, or a portion thereof. The plate 10 serves to secure an end of the bridge 3 to the body 2 when the bridge 3 is in the released position as shown. Alternatively, the plate 10 may be omitted, in which case the bridge 3 may be operatively connected to the hinge 9, which in turn may be secured directly to the body 2.

Although the bridge system 11 is depicted as being mounted on the body 2, it is to be understood that the bridge may be positioned anywhere on the instrument 1 which is substantially opposite from where an opposite end of the strings 7 are secured. Accordingly, where the instrument is a guitar or the like wherein the strings 7 are secured and tuned at the body 2, rather than the head 4, the bridge system 11 may be positioned on the head 4. Other embodiments apparent to one of ordinary skill in the art are envisioned to be within the scope and spirit of the present invention.

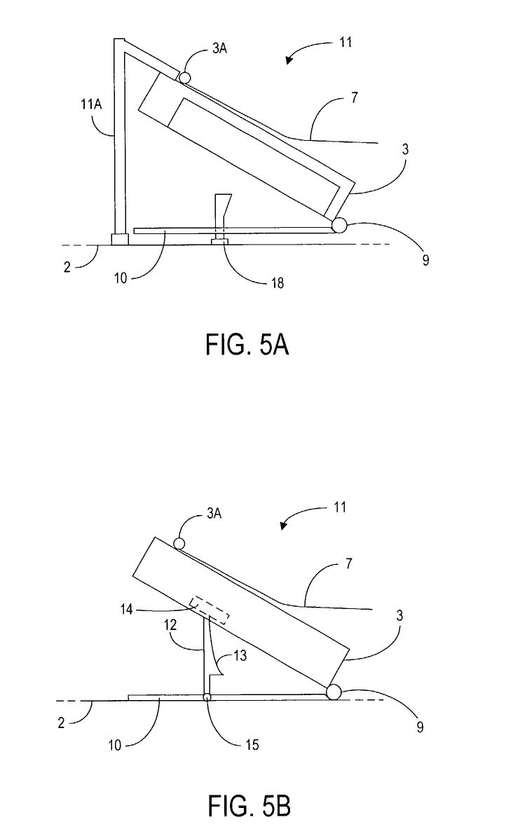

Turning now to FIG. 5A, therein is depicted a side view of an embodiment of a bridge system 11 which may further include a catch 11A and a release mechanism 18. The release mechanism 18 may be provided with the bridge system 11 or separately therefrom. When the release mechanism 18 is in a first position, the end of the bridge 3 opposite the hinge 9 is held in a secured position to the body 2. When the release mechanism 18 is moved to a second position, that end of the bridge 3 is released from the body 2 to a second position. This release is caused at least in part, by the tensile force exerted by the strings 7, such force being between the bead 4 and the bridge 3 when secured to the body 2. The released end of the bridge 3 may be released to any operable distance from the body 2. By way of example only, the bridge may be released to a position where the tensile force exerted by the strings is fully diminished. However, the bridge may move to any position where the tensile force is reduced.

Preferably however, the bridge 3 is secured in a second position by the catch 11A at a distance that does not allow the plurality of strings 7 to be unguided by nut 5. A release to such distant simplifies re-establishment of the string tension without having to individually re-engage each string with its proper position on the nut. Thus, there may be a de minimis tensile force that still exists between the head 4 and body 2 when the bridge is released which is necessary to prevent the strings 7 from becoming unguided. However, such minuscule force will not impact the flatness of neck 6 in as drastic a manner as with instruments of the prior art. Experimentation has revealed that a distance of 0.5 inches between the released end of bridge 3 and body 2 is acceptable.

The catch 11A may include a securing arm allows the length of the securing arm to be adjusted, thereby allowing the bridge, when placed in a released position from the body, to be held by the securing arm at various distances. This in turn allows a musician to adjust the degree to which the bridge is released.

When a user of the instrument 1 wishes to play the instrument after the bridge 3 has been released, the bridge may be manually depressed back into the first position. In further embodiments, a mechanism may be employed to mechanically or electro-mechanically re-engage the bridge to its secured position. Experimentation has revealed that if the bridge 3 is in a second position for a brief amount of time, the original tuning of the strings is substantially restored. As the amount of time increases, the tuning of the strings may increasingly deviate from their original tuning.

The release mechanism 18 disclosed above may be any device which accomplishes these above functions. Such devices may include a latch, a spring latch, a release-and-hold device 12 (described further hereinbelow) and the like. When the release mechanism 18 employed is a spring latch, the release mechanism 18 may be actuated to release the bridge 3 by moving the release mechanism between a first and a second position. After the bridge has been released, the spring in the latch may return the release mechanism to its first position. The release mechanism 18 may be provided in any position substantially near the end of bridge 3 that is to be released, but is preferably disposed at any side of the bridge which is parallel to neck 6 so as to avoid interfering with the play of the instrument 1.

The catch 11A is disposed on the body 2 so as to secure the bridge 3 in a second position when the bridge 3 is released to that position after release mechanism 18 has been actuated. The catch 11 A may be provided to consumers with the bridge system 11 or separately therefrom. Furthermore, the catch 11A may be disposed in any location on the body wherein it may secure the bridge 3 to the second position, but is preferably disposed at an end of the bridge 3 substantially opposite in position to the neck 6 so as to avoid interfering with the play of the instrument 1. The catch may engage a lip portion of the bridge that is provided for such purpose or may engage the bridge, for example, on its upper face. Any number of catches 11A may be provided, and may be individually or simultaneously activated.

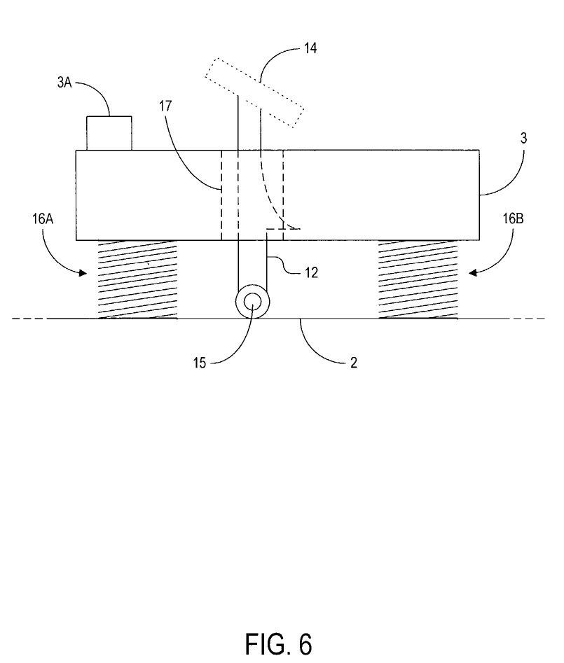

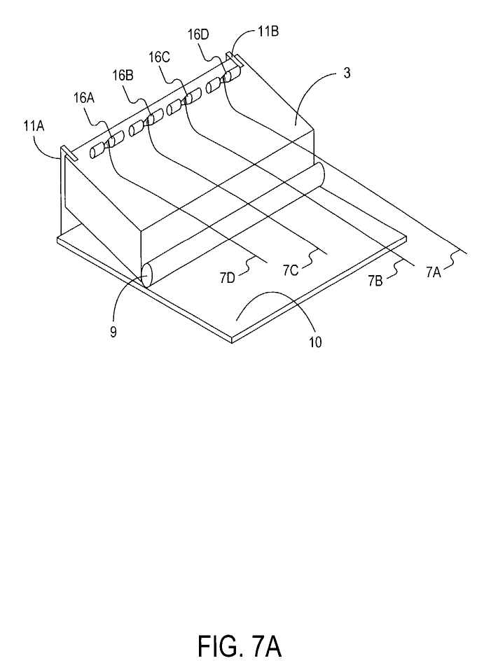

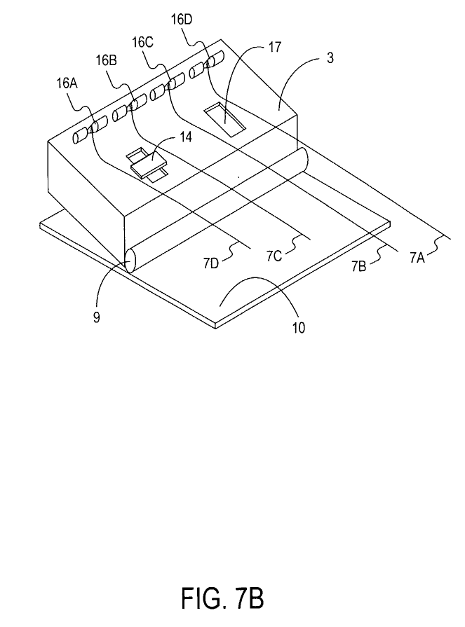

Turning now to FIG. 5B, therein is depicted a side view of a further embodiment of the bridge system 11 wherein the functions of the release mechanism 18 and the catch 11A are performed by the same device 12. The release-and-hold device 12 may be disposed substantially within the bridge 3, which, in turn, may have a hole 17 therethrough (described with regard to FIGS. 6, 7A and 7B) to accommodate the device 12. The release-and-hold device 12 is secured to either plate 10, or through an opening (not shown) in plate 10 to the body 2. The end of release-and-hold device 12 is secured by a rotation member 15. Rotation member 15 allows the device 12 to be moved between a first and a second position so that the bridge 3 may be released from a secured position to a released position on the body. The rotation member 15 may be any mechanism for accomplishing this function, and is preferably a spring hinge mechanism wherein the spring assists in returning the device 12 to a first position after being actuated.

When the bridge 3 and the device 12 are both in a first, secured position, a latch 13 holds the bridge 3 in place on the body 2. This may be accomplished by providing a lip (not shown) on the bridge to mate with the latch 13. The device 12, when actuated to a second position holds the bridge 3 in a second, i.e. released, position by a catching member 14. The bridge 3 may be returned to the first position by manually depressing the bridge such that the latch 113 is re-engaged. Catching member 14 thus protrudes from the top of bridge 3 when the bridge 3 is in a secured position and further allows for actuation of the device 12. Latch 13 meets the bottom internal portion of the bridge 3 when the bridge 3 is secured. Catching member 14 meets the top exterior portion of the bridge 3 when the bridge 3 is released to a second position. Catching member 14 may be any device which accomplishes this function and is disposed between and/or underneath the plurality of strings 7 so as to avoid interfering with the play of the instrument 1.

Turning now to FIG. 6, therein is depicted a further embodiment of the present invention wherein the bridge 3 is secured to the body 2 by a plurality of springs 16A and 16B. A first end of the springs 16A, 16B are secured to the body 2, or alternatively to, a plate which is secured to the body 2 as shown previously in FIG. 4. The bridge 3 is in a similar configuration to that described with regard to FIG. 5B. That is, there is a hole 17 disposed within the bridge 3 to accommodate a release-and-hold device 12. The release-and-hold device 12 may be of various configurations, and may be actuated by rotating the device 12 from a first position to a second position about rotation member 15. When the device 12 in the first position, the bridge 3 is secured in a first position to the body 2 by the latch 13 and spring 16A and 16B are compressed. When the device 12 is moved to a second position, the bridge 3 is release to a second position, the tensile force is reduced and the springs 16A and 16B are decompressed. The bridge 3 may be returned to a secured position on the body 2 by manually depressing the bridge 3 back to its first position.

FIGS. 7A and 7B depict a perspective view of alternate embodiments of the bridge system 11 as displayed in FIGS. 5A and 5B. String holders 3A are depicted individually as elements 16A-16D. A plurality of catches 11A and 11B may be provided therewith as depicted in FIG. 7A. Alternatively, there may be a plurality of release-and-hold devices 12 disposed within a plurality of holes 17, as depicted in FIG. 7B. In the latter embodiment of FIG. 7B, the catching members 14 may be disposed along and/or within the bridge 3 so as not to interfere with the play of the instrument 1.

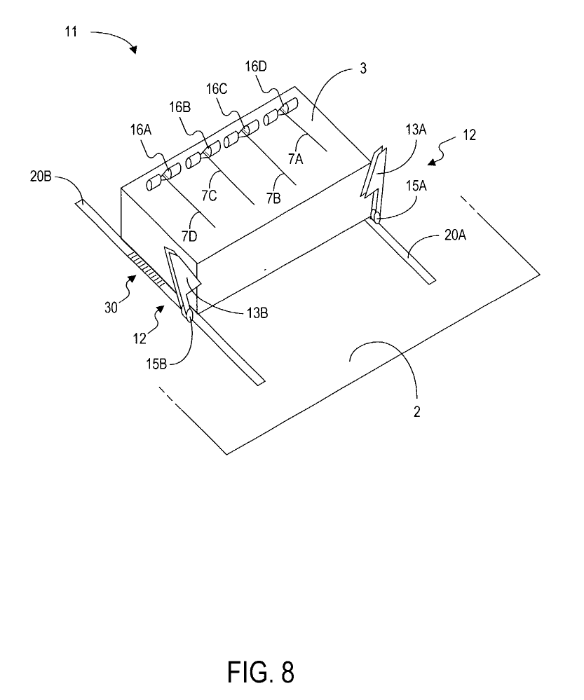

A further embodiment of the present invention is depicted in perspective view in FIG. 8. The bridge system 11 includes a bridge 3 which optionally includes string holders 16A-16D, and further has a guide 30 for securing the bridge to a plurality of rails 20A and 20B. The rails 20A, 20B are, in turn, secured to the body 2 of musical instrument 1 on either side of the bridge 3. Alternatively, the rails 20A, 20B may be provided underneath the bridge 3 on the body 2. The bridge 3 is secured in a first position by latches 13A and 13B of release-and-hold devices 12. The devices 12 are in turn secured to body 2 by rotation members 15A and 15B. When the devices 12 are moved from a first position to a second position, the bridge 3 is forced by the tensile force of plurality of strings 7 to move along rails 20A and 20B to a second position wherein the tensile force is decreased. The bridge may be secured in the second position by the end of each of rails 20A and 20B. Alternatively a further catch or catching member (not shown) may be employed to hold the released bridge 3 at a second position in a manner similar to the embodiments discussed above, or in any manner apparent to one of ordinary skill in the art. The bridge 3 may be returned to its first secured position by manually pressing the bridge back into place.

One skilled in the art will appreciate that while the invention has been illustrated in terms of particular embodiments disclosed in the foregoing, other equivalents and embodiments are contemplated to be within the spirit and scope of the present invention. For example, and in accordance with the instant invention, a release mechanism, a catch, a string holder and any individual, necessary or, perhaps, ornamental components are, in any combination, contemplated to be included with a bridge or to be provided separately therefrom. The subject matter disclosed in the foregoing should, therefore, not be construed as solely limiting the spirit and scope of the invention, which are particularly pointed out and distinctly recited by the appended claims.

We claim.

1. A bridge system mountable on a stringed musical instrument, the bridge system comprising:
a bridge for securing an end of at least one string of a stringed instrument,
a hinge operatively disposed between the bridge and the stringed instrument for securing a first end of the bridge to the stringed instrument;
a release mechanism disposed to engage a second end of the bridge, for holding the second end of the bridge in a first, secured position on the stringed instrument, wherein upon actuation of the release mechanism, the release mechanism becomes disengaged from the second end of the bridge and a tension of the at least one string causes the second end of the bridge to move to a second, released position in which the tension is at least partially decreased, and the release mechanism must be re-engaged to replace the bridge in the first, secured position.

2. The bridge system of claim 1, further comprising:
a catch for engaging the bridge in the second, released position at a predetermined distance from the stringed instrument.

3. The bridge system of claim 2, said bridge having a hole therethrough for accommodating the catch, the catch having an engaging member for engaging the bridge in at least one of the first and second positions.

4. The bridge system of claim 2, said catch including an adjustable securing arm, whereby the length of the arm may be adjusted to bold the bridge at various distances from the stringed instrument.

5. A method for modifying string tension of a stringed musical instrument, the method comprising:
securing an end of a bridge in a first position on a stringed instrument by engaging a release mechanism with the end of the bridge;
activating the release mechanism, thereby allowing a string tension of a string of the stringed instrument held by the bridge to move the end of the bridge to a second position away from the stringed instrument where the string tension is at least partially reduced; and
holding the end of the bridge in the second position by a catch.

6. The method of claim 5, further comprising:
adjusting a securing arm of the catch, thereby adjusting a distance from the stringed instrument to which the bridge is released.

7. The method of claim 5, further comprising:
restoring the bridge to the first position wherein the release mechanism may reengage the end of the bridge and the string tension is substantially restored.
